(19) United States
(12) Patent Application Publication
(10) Pub. No.: US 2002/0010669 A1
(43) Pub. Date: Jan. 24, 2002

(54) System and method for identifying potential participants in a public offering

(76) Inventor: Brian Street, Boca Raton, FL (US)

Correspondence Address: GREENBERG-TRAURIG, 1750 TYSONS BOULEVARD, 12TH FLOOR, MCLEAN, VA, 22102, US

(21) Appl. No.: 09/859,666

(22) Filed: May 18, 2001

Related U.S. Application Data
(60) Provisional application No. 60/205,108, filed on May 18, 2000.

(51) Int. Cl. G06F 17/60

(52) U.S. Cl. 705/36

(57) ABSTRACT

A method of allocating IPO securities includes the steps of publishing criteria for a customer's participation in a rights offering by an issuer, tracking purchases by the customer from the issuer, allocating a portion of IPO securities to the customer based on the purchases.

This application claims priority to U.S. Provisional Patent Application No. 60/205,108, filed on May 18, 2000.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Field of the Invention

This invention relates to distribution of shares prior to an initial public offering (IPO), and more particularly, to rewarding customers who contributed to an issuer's market success with pre-IPO securities.

2. Discussion of the Related Art

A public offering is the offering of an entity's securities to the public, pursuant to an effective registration statement filed, e.g., with the Securities Exchange Commission, or as may otherwise be permitted by law.

Typically, prior to initiating a public offering, a number of shares are pre-allocated by the entity for sale to a group of identified investors. This list of investors to whom the allocated shares will be offered is frequently determined by the entity and/or the underwriters making the offering, and is known as the “friends and family” list. While the naming of an investor on such a list is at the discretion of the entity and/or the underwriters making the offering, it is also known for the entity and/or the underwriters to establish rules governing eligibility of individuals to participate in the offering at the offering price. For example, it is known for entities and/or underwriters to allocate shares in a public offering to persons on a list comprised of employees and/or consultants of the company.

However, prior art methods for compiling and administering such lists ordinarily have at least one thing in common: each method gives significant discretion to the offering entity and its underwriters in the determination of which parties will be allowed to participate in the offering. Such discretion has lead to the inequitable distribution of shares and has failed to promote broad participation in offerings.

### SUMMARY OF THE INVENTION

Accordingly, the present invention is directed to a system and method for identifying potential participants in a public offering that substantially obviates one or more of the problems due to limitations and disadvantages of the related art.

It is therefore an object of the invention to provide an improved system and method for compiling and administering a list of parties for participation in a public offering.

It is a further object of the invention to provide a non-discriminatory, non-discretionary and non-arbitrary system and method for compiling and administering a list of parties for participation in a public offering.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, in one aspect of the present invention there is provided a method of allocating IPO securities including the steps of publishing criteria for a customer's participation in a rights offering by an issuer, tracking purchases by the customer from the issuer, and allocating a portion of IPO securities to the customer based on the purchases.

In another aspect of the present invention there is provided a system for allocating IPO securities including the steps of means for publishing criteria for a customer's participation in a rights offering by an issue, means for tracking purchases by the customer from the issuer, and means for allocating a portion of IPO securities to the customer based on the purchases.

In another aspect of the present invention there is provided a reward system including, right of at least one customer of an issuer to participate in a public offering of the issuer, and at least one published criteria for the at least one customer having a relationship with the issuer, the right being conditioned on the at least one customer assisting a market expansion of the Issuer in a formative stage, by making purchases from the issuer.

In another aspect of the present invention, there is provided a method for allocating initial public offering (IPO) shares including the steps of capturing data related to a customer's identification codes, quantifying market penetration assistance provided by the customer via a purchase from an issuer, at a time of the IPO, data, storing the data in a customer database file record for each specific customer, comparing the data as stored in the customer database file with at least one pre published allocation formula, and distributing IPO securities prior to the IPO to the customer based on the data comparing step.

It is to be understood that both the foregoing general description and the following detailed description are exemplary and explanatory and are intended to provide further explanation of the invention as claimed.

### BRIEF DESCRIPTION OF THE ATTACHED DRAWING

The accompanying drawing, which is included to provide a further understanding of the invention and are incorporated in and constitute a part of this specification, illustrates an embodiment of the invention and together with the description serves to explain the principles of the invention.

In the drawing:

FIG. 1 shows a flow diagram illustrating the process steps of the invention in accordance with a preferred embodiment.

### DETAILED DESCRIPTION OF THE PREFERRED EMBODIMENTS

Reference will now be made in detail to the preferred embodiments of the present invention, examples of which are illustrated in the accompanying drawing.

A system and method are provided which permit certain customers of an entity to have the opportunity to acquire rights to participate in a public offering of equity interests in such entity, based upon prior, current, and/or future patronage of the services or products of such entity, with the right to acquire the rights to participate determined in accordance with a formulae that is developed by the entity, disseminated publicly in conjunction with a registration statement covering the rights to participate in a public offering of such entity's equity interests, and applied on a non-discriminatory basis and on a non-discretionary basis to its customers. Multiple lists may be provided in accordance with the invention, and such list or lists may be created to complement other lists of potential participants created in accordance with the prior art.

Customers using the system may be, e.g., any person or business which avails itself of the services of or acquires the products of the entity. The entity may be, e.g., any corporation, partnership, limited liability company, trust or other recognized vehicle used to carry on business activities.

For purposes of this disclosure, an “issuer” is any entity which intends to or is offering equity interests in itself to the public.

Potential participants are those persons or organizations who will be given the opportunity to acquire rights to participate in the public offering because they were identified by applying the formula.

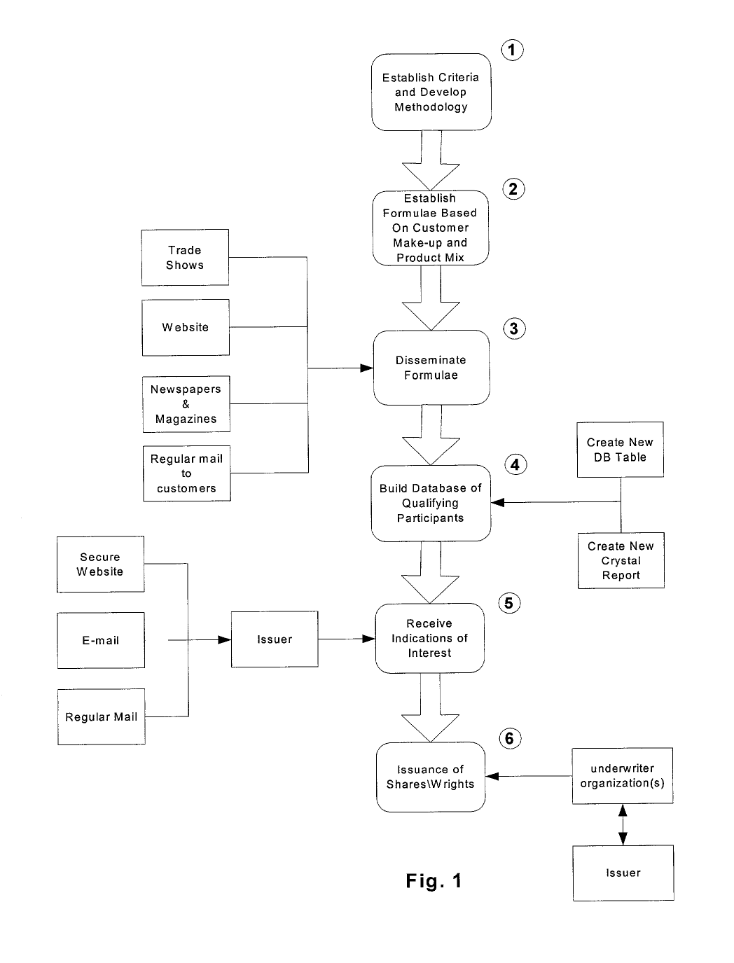

In a preferred embodiment, potential participants are identified in accordance with the methodology shown in FIG. 1. Each step is described below with reference to FIG. 1.

At step 1, a set of criteria is established leading to a methodology and the development of formulae, the purpose of which is to identify, on a non-discriminatory and non-arbitrary basis, certain persons or organizations who are customers of the issuer, after the formulae is made public, and as a result of the application of the formulae, such persons may acquire rights to participate in a public offering of the equity interests of such entity. The formulae preferably uses identifiable, objective and quantifiable criteria to determine such potential participants. The formulae are based on a fixed, prearranged methodology that, when followed, will determine on a non discriminatory and non discretionary basis, a group of persons or organizations. The criteria can be grouped and customized for accommodating/rewarding any type of user (individual, large firm, small firm, federal/state/local government, not-for-profit organization, etc.) or for promoting any particular product/service in the issuer's product mix.

At step 2, the formulae are crafted based on the criteria and methodology developed in step 1. The objective is to accommodate customers of various size and type while providing them incentives to purchase services/products of an entity. Another objective may be to indirectly provide incentives to the customers to use any specific service/product of an entity. Yet another objective may involve the promotion of purchase/use of certain products/services over a pre-assigned time frame.

To illustrate the interplay between various elements as described above, and the determination of a point system leading to granting rights to purchase stock, an example is provided in the next paragraph. The example should not be interpreted as all inclusive or too restrictive.

Individual Customer=C_{I}

Small Company with no branch offices=C_{S}

Large Company with multiple branches=C_{L}

Federal, state or local government=C_{G}

Not-for-profit organization=C_{N}

Prices of offerer's Products ($)=a, b, c . . . , n

Weighted value ($) of product purchases=D

Time frame associated with purchase of each of the products, a, b, . . . , n=tₐ, t_{b}, . . . , tₙ

Weighted value of time frame segments (in months) associated with purchase of each of the products, a, b, . . . , n=t₁, t₂, . . . , t_{IPO}

Points to be Awarded Towards Stock Purchase Rights=P

Customer shares set aside=S_{c}

Total Shares=Sₜ

Formula 1

P_{C}_{_{I}}=D_{C}_{_{I}}(S_{c}/Sₜ)×1

Formula 2

P_{C}_{_{S}}=D_{C}_{_{S}}(S_{c}/Sₜ)×0.4

Formula 3

P_{C}_{_{L}}=D_{C}_{_{L}}(S_{c}/Sₜ)×0.2

Formula . . .

. . .

Formula n

. . .

The ratio utilized to compute P (such as Sc/Sₜ, 1, 0.4, etc.) may be arbitrary, depending on the “issuer's” desire to control the total number of points awarded.

At step 3, the above formulae are disseminated publicly to inform and permit customers of the issuer who have an interest in acquiring rights to participate in a public offering of the equity interests of such entity to acquire such rights. As illustrated in FIG. 1, the formulae may be disseminated via print media (newspaper, newsletter, memorandum send through mail, etc.), non-print media (radio, television, telephone, etc.) or electronically (e-mail, website, etc.). The dissemination of the formulae may itself be a rights offering, and therefore be subject to compliance with state and/or federal securities laws. Where the invention is practiced in the United States, the dissemination of the formulae may be subject to filing a registration statement under the Securities Act of 1933, and may be accompanied by a prospectus.

At step 4, either concurrently with or after dissemination of the formulae to the public, the issuer invokes a system to identify those customers who are attempting to acquire rights to participate in a public offering of the equity interests of such entity. The system applies the formulae to determine who the potential participants are. The formulae may be applied to, e.g., a database of sales information, and the application of the formulae results in a database of qualifying participants. Such identification is made using the formulae on a non-discriminatory and non-discretionary basis, preferably conditioned only upon limitations which may arise under the securities laws or which may be imposed by the issuer's underwriter. As potential participants qualify (e.g., by making purchases from the entity of a certain dollar value of goods or services over a pre-defined time frame) the system continuously applies the formulae and automatically notifies each qualifying customer of their rights utilizing a point system by, e.g., transmitting to the customer a certificate and/or statement. As a potential participant qualifies for more shares over time, the system transmits to the participant an updated statement and/or a new certificate. The process of database building and qualifying of participants is shown in FIG. 1. One can incorporate the process involved in step 4 simply into an existing database, if one already exists. A new table will be created within the database that includes the customer number, the recipient name, the factors used in determining the formulae for that individual customer, a data range that the software will use to determine the amount of points that have accumulated during a certain time period.

Any report generating software, such as the Crystal Reports, may be used in the implementation. One would simply perform a lookup on the charges table for a given customer, determine the total charges for the given date range, lookup the point generation formulae to determine the points generated and accumulated, and then determine the number of warrants/rights/shares to be issued.

At step 5, qualifying potential participants submit indications of interest, establishing their interest in actually participating in the public offering. For example, a potential participant who has qualified and been granted rights to purchase fifty shares at the initial public offering may submit an indication of interest establishing that they wish to actually purchase thirty shares. The qualifying participants preferably submit such indications after the participants' actions, which qualify them for participation. However, it will be recognized by those skilled in the art that the submission may also be made prior to or concurrently with the qualifying action. For example, if the qualifying action is the purchase of goods or services, the submission of an indication of interest by the participant can be made at the time of the sale of the goods or services. The submission may be received electronically, e.g., via a secure web page to which the potential participants are directed, and may be submitted in response to a communication from the entity or underwriters inquiring as to the amount of shares that the potential participant desires to acquire. The website software can be chosen or the existing software modified to allow for the transfer of the appropriate information to the database referred to in step 4. Various methods of participant interest submissions can be arranged as shown in FIG. 1.

At step 6, at the time of the public offering, the underwriters or the entity then issue the securities to the participant.

A non-limiting example of a formulae which may be used in accordance with the invention is as follows: A set of formulae is disseminated publicly stating that each customer who had been, as of the date of dissemination, or will be in the future, a customer and had paid or will in the future pay the issuer at least two hundred fifty ($250) U.S. dollars in connection with using the issuer's services prior to or after the date of dissemination of the formulae will be eligible to receive a certificate entitling them to purchase ten (10) shares in the public offering. Such Customer is eligible to acquire, at the initial offering price, an amount of shares equal to ten (10) shares for the first two hundred fifty ($250) U.S. dollars of services that they have paid the issuer for and one (1) additional share for each additional twenty five ($25) U.S. dollars of services for which they have paid the issuer. As customers make purchases, the system continually applies the formulae and notifies each customer of their rights by, e.g., transmitting to the customer a certificate and/or statement. A cut-off date of ten (10) business days prior to the effective date of the public offering is set, after which potential participants cannot qualify to receive shares by making further purchases. At this point, all indications of interest must also be received from the recipients.

It will be recognized by those skilled in the art that many variations on the above formulae are possible. For example, the formulae may be defined so as to identify pre-issue, current, and/or future customers of the entity as potential participants.

The invention as described in detail above provides significant advantages as follows. First, it rewards customers of the issuer, who are identified in accordance with the formulae, by giving them the opportunity to participate in the public offering of the issuer's securities. Further, the invention rewards those customers who have assisted in the issuer's success because they were customers of the issuer, rather than simply being identified as friends or family of the issuer. The invention also promotes the Securities and Exchange Commission's policy of affording equitable distribution of securities in connection with a public offering. Finally, once the set of formulae has been established and disseminated publicly, the issuer no longer has any control whatsoever with respect to those customers who may become potential participants.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method of allocating IPO securities comprising the steps of:
publishing criteria for a customer's participation in a rights offering by an issuer;
tracking purchases by the customer from the issuer; and
allocating a portion of IPO securities to the customer based on the purchases.

2. The method of claim 1, further including the step of receiving an indication of customer interest.

3. The method of claim 2, wherein the indication of customer interest is received via mail.

4. The method of claim 2, wherein the indication of customer interest is received via email.

5. The method of claim 2, wherein the indication of customer interest is received via a secure website.

6. The method of claim 1, further including the step of assigning a point value to each purchase by the customer.

7. The method of claim 6, wherein the step of allocating uses point values accumulated by the customer.

8. The method of claim 7, wherein the point values are calculated based on at least one of frequency of purchase, dollar value of purchase, and physical volume of purchase.

9. The method of claim 7, wherein the point value areas calculated based on customer profile.

10. The method of claim 1, further including the step of recording the purchases in a database.

11. The method of claim 10, further including the step of continually updating the database, wherein the customer is given access to the database.

12. The method of claim 1, wherein the customer is a potential customer.

13. The method of claim 1, wherein the customer is a former customer.

14. The method of claim 1, further including the step of registering the criteria with the Securities and Exchange Commission.

15. The method of claim 1, further including the step of publishing a plurality of criteria for the customer participation.

16. The method of claim 1, wherein a plurality of customers are given a right to participate in the rights offering.

17. The method of claim 1, wherein the purchase includes a purchase of goods.

18. The method of claim 1, wherein the purchase includes a use of services.

19. The method of claim 1, wherein the rights offering is an equity offering.

20. The method of claim 1, wherein the rights offering is independent of a total number of authorized shares, shares to be offered via the IPO, the ratios of already assigned shares to total authorized or IPO shares and any restrictions on stipulated dilution.

21. The method of claim 1, wherein the customer purchases include purchases in a formative stage of the issuer.

22. The method of claim 1, wherein the step of publishing includes the step of disseminating the criteria in at least one of print media, web site, mail, email, and trade show.

23. A system for allocating IPO securities comprising the steps of:
means for publishing criteria for a customer's participation in a rights offering by an issuer;
means for tracking purchases by the customer from the issuer; and
means for allocating a portion of IPO securities to the customer based on the purchases.

24. The system of claim 23, further including means for receiving an indication of customer interest.

25. The system of claim 24, wherein the indication of customer interest is received via mail.

26. The system of claim 24, wherein the indication of customer interest is received via email.

27. The system of claim 24, wherein the indication of customer interest is received via a secure website.

28. The system of claim 23, further including means for assigning a point value to each purchase by the customer.

29. The system of claim 28, wherein the means for allocating uses point values accumulated by the customer.

30. The system of claim 28, wherein the point values are calculated based on at least one of frequency of purchase, dollar value of purchase, and physical volume of purchase.

31. The system of claim 28, wherein the point values are calculated based on customer profile.

32. The system of claim 23, further including means for recording the purchases in a database.

33. The system of claim 23, further including means for continually updating the database, wherein the customer is given access to the database.

34. The system of claim 23, wherein the customer is a potential customer.

35. The system of claim 23, wherein the customer is a former customer.

36. The system of claim 23, further including means for registering the criteria with the Securities and Exchange Commission.

37. The system of claim 23, further including means for publishing a plurality of criteria for the customer participation.

38. The system of claim 23, wherein a plurality of customers are given a right to participate in the rights offering.

39. The system of claim 23, wherein the purchase includes a purchase of goods.

40. The system of claim 23, wherein the purchase includes a use of services.

41. The system of claim 23, wherein the rights offering is an equity offering.

42. The system of claim 23, wherein the rights offering is independent of a total number of authorized shares, shares to be offered via the IPO, the ratios of already assigned shares to total authorized or IPO shares and any restrictions on stipulated dilution.

43. The system of claim 23, wherein the customer purchases include purchases in a formative stage of the issuer.

44. The system of claim 23, wherein the means for publishing includes means for disseminating the criteria in at least one of print media, web site, mail, email, and trade show.

45. A reward system comprising:
a right of at least one customer of an issuer to participate in a public offering of the issuer; and
at least one published criteria for the at least one customer having a relationship with the issuer, the right being conditioned on the at least one customer assisting a market expansion of the Issuer in a formative stage, by making purchases from the issuer.

46. The method of claim 45, wherein the right is independent of a total number of authorized shares, shares to be offered via the IPO, the ratios of already assigned shares to total authorized shares and any restrictions on stipulated dilution.

47. The system of claim 45, wherein the purchases include a purchase of goods.

48. The system of claim 45, wherein purchases include a use of services.

49. A method for allocating initial public offering (IPO) shares comprising the steps of:
capturing data related to a customer's identification codes;
quantifying market penetration assistance provided by the customer via a purchase from an issuer, at a time of the IPO;
storing the data in a customer database file record for each specific customer;
comparing the data as stored in the customer database file with at least one pre published allocation formula; and
distributing IPO securities prior to the IPO to the customer based on the step of comparing the data.

50. The method of claim 49, wherein the method is performed by authorized personnel of the issuer, and
wherein a customer community is provided with individual scores to determine reward status prior to the IPO based on the data.

51. The method of claim 49, wherein the customer database file record includes a plurality of fields defining point levels to be achieved for market penetration assistance for earning a right to the distribution of the IPO securities, and
wherein the point values are computed for each field of the customer database file record to create a relationship score.

52. The method of claim 51, wherein point values are computed based on at least one of frequency of purchase, dollar value of purchase, and physical volume of purchase.
